(19) United States
(12) Patent Application Publication
(10) Pub. No.: US 2025/0242239 A1
(43) Pub. Date: Jul. 31, 2025

(54) STORAGE MEDIUM, INFORMATION PROCESSING SYSTEM, INFORMATION PROCESSING APPARATUS, AND IMAGE PROCESSING METHOD

(71) Applicant: NINTENDO CO., LTD., Kyoto (JP)

(72) Inventors: Yasuhito FUJISAWA, Kyoto (JP); Taiju MIYAKITA, Kyoto (JP)

(21) Appl. No.: 18/883,174

(22) Filed: Sep. 12, 2024

(30) Foreign Application Priority Data
Jan. 29, 2024 (JP) 2024-011042

(51) Int. Cl. A63F 13/52

(52) U.S. Cl. CPC A63F 13/52

(57) ABSTRACT

For each of a plurality of first type of objects among objects in a virtual space, a partial space is set. An exemplary information processing system generates, for each object, a partial shadow map that is a shadow map for the first type of object in the partial space. Regarding pixels corresponding to a range of the partial space, the exemplary information processing system determines, for each pixel, a density of shadow of the first type of object, based on a depth in the depth buffer and a depth of the partial shadow map. If the density of shadow of the pixel has a value indicating a denser shadow than a value stored in a shadow buffer that stores densities of shadows, the density of shadow of the pixel is overwritten stored in the shadow buffer. An image with a shadow is rendered based on the shadow buffer.

### CROSS REFERENCE TO RELATED APPLICATION

This application claims priority to Japanese Patent Application No. 2024-011042, filed on Jan. 29, 2024, the entire contents of which are incorporated herein by reference.

### FIELD

The present disclosure relates to a storage medium, an information processing system, an information processing apparatus, and an image processing method for generating an image in which a shadow is added to an object in a virtual space.

### BACKGROUND AND SUMMARY

Conventionally, there is a technique using a shadow map to generate an image in which a shadow is added to an object in a virtual space.

It is desired to reduce processing load on a computer due to a process for generating the image with the shadow.

Therefore, the present application discloses a storage medium, an information processing system, an information processing apparatus, and an image processing method capable of reducing processing load on a computer in generating an image with a shadow.

(1)

An example of one or more non-transitory computer-readable media having described herein stores therein instructions that, when executed, cause one or more processors of an information processing apparatus to execute information processing comprising: regarding objects in a virtual space, performing rendering to a frame buffer or a G buffer while performing a depth test using a depth buffer; regarding a plurality of first type of objects among the objects in the virtual space, for each first type of object, setting a partial space that is a part of the virtual space and encloses the first type of object, setting a virtual light source corresponding to the partial space, and generating a partial shadow map that is a shadow map for the first type of object in the partial space based on the virtual light source, and regarding pixels corresponding to a range of the partial space, determining, for each pixel, a density of shadow of the first type of object, based on a depth in the depth buffer and a depth of the partial shadow map, and if the density of shadow of the pixel has a value indicating a denser shadow than a value stored in a shadow buffer that stores densities of shadows, overwriting and storing the density of shadow of the pixel in the shadow buffer; and rendering a shadow in an image in the frame buffer, based on the frame buffer and the shadow buffer, or rendering an image with a shadow in the frame buffer, based on the G buffer and the shadow buffer.

According to the configuration of the above (1), using the partial shadow map for each object can reduce the processing load on the computer.

(2)

In configuration (1) above, the information processing may include determining the density of shadow for each of the pixels corresponding to the range of the partial space, based on a method of variance shadow mapping using the depth in the depth buffer and the depth of the partial shadow map.

According to the configuration of the above (2), the variance shadow map allows a shadow that looks natural to be displayed while inhibiting light bleeding.

(3)

In configuration (2) above, the first type of object may be a flat-shaped object.

According to the configuration of the above (3), it is possible to further reduce the risk of occurrence of light bleeding.

(4)

In configuration (1) above, the virtual light source may be a parallel light source. The partial space may have a rectangular parallelepiped shape having sides along a direction of light from the parallel light source.

According to the configuration of the above (4), calculations for generating the partial shadow map can be facilitated.

In the present specification, examples of an information processing apparatus and an information processing system for executing the processes in the above (1) to (4) are disclosed. Moreover, in the present specification, an example of an image processing method for executing the processes in the above (1) to (4) is disclosed.

According to the storage medium, the information processing system, the information processing apparatus, and the image processing method, the processing load on the computer can be reduced.

These and other objects, features, aspects and advantages of the exemplary embodiment will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a game image;

FIG. 9 is a view showing an example of a predetermined type of object placed in a virtual space;

FIG. 10 is a view showing an example of partial spaces set for objects;

FIG. 11 is a view showing an example of partial spaces according to a modification of the exemplary embodiment;

FIG. 12 is a view showing an example of positional relationship between a light source, an object, and a surface to which a shadow of the object is added;

FIG. 13 is a view showing an example of an object and a region to be a shadow of the object;

FIG. 14 is a view showing an example of a game image in which shadows of two objects are displayed so as to overlap each other;

FIG. 15 is a view showing an example of updating a shadow buffer;

FIG. 16 is a view showing an example of a game image in which shadows of two objects are displayed so as to overlap each other;

FIG. 17 is a view showing an example of storage areas in which various data to be used for information processing in a non-limiting game system;

FIG. 18 is a flowchart showing an example of a flow of game processing executed by a non-limiting game system;

FIG. 19 is a sub-flowchart showing an example of a specific flow of a rendering process in step S3 shown in FIG. 18;

FIG. 20 is a sub-flowchart showing an example of a specific flow of a shadow buffer updating process in step S17 shown in FIG. 19;

FIG. 21 is a sub-flowchart showing an example of a specific flow of a variance shadow mapping process in step S23 shown in FIG. 20; and

FIG. 22 is a sub-flowchart showing an example of a specific flow of a lighting process in step S18 shown in FIG. 19.

### DETAILED DESCRIPTION OF NON-LIMITING EXAMPLE EMBODIMENTS

### [1. Configuration of Game System]

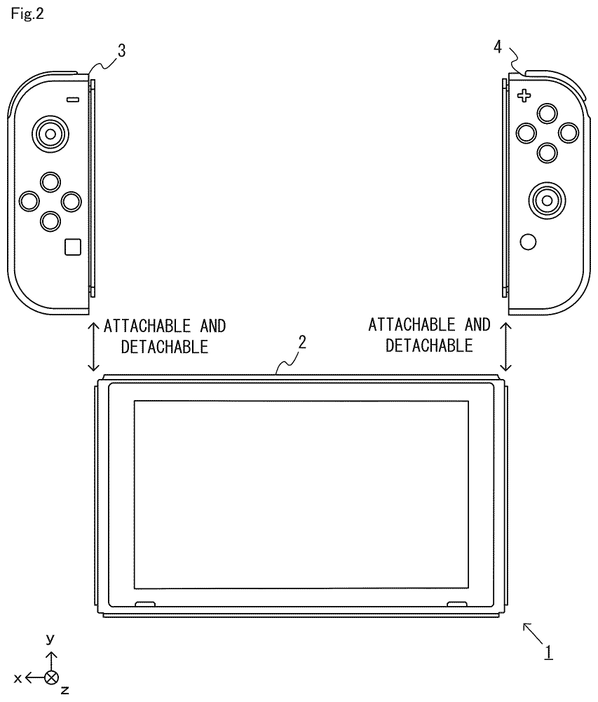

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

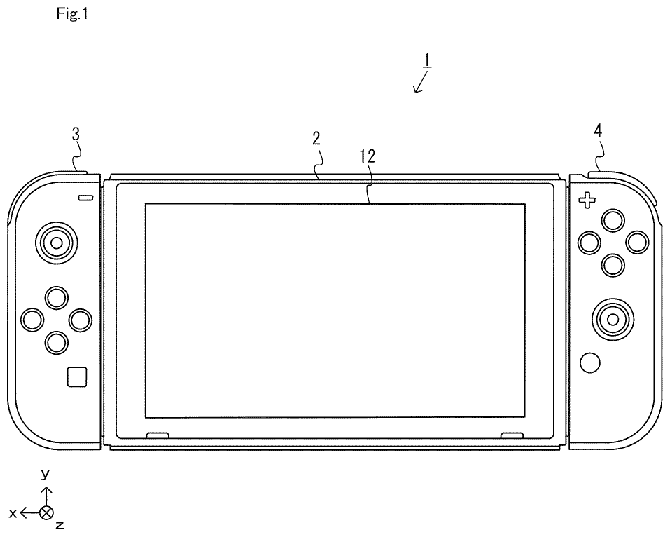

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

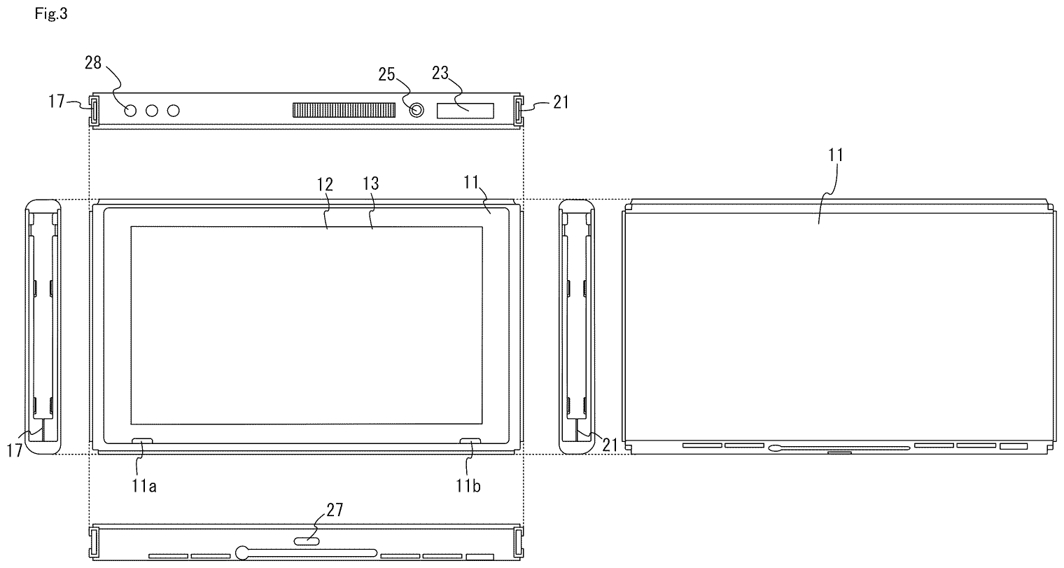

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

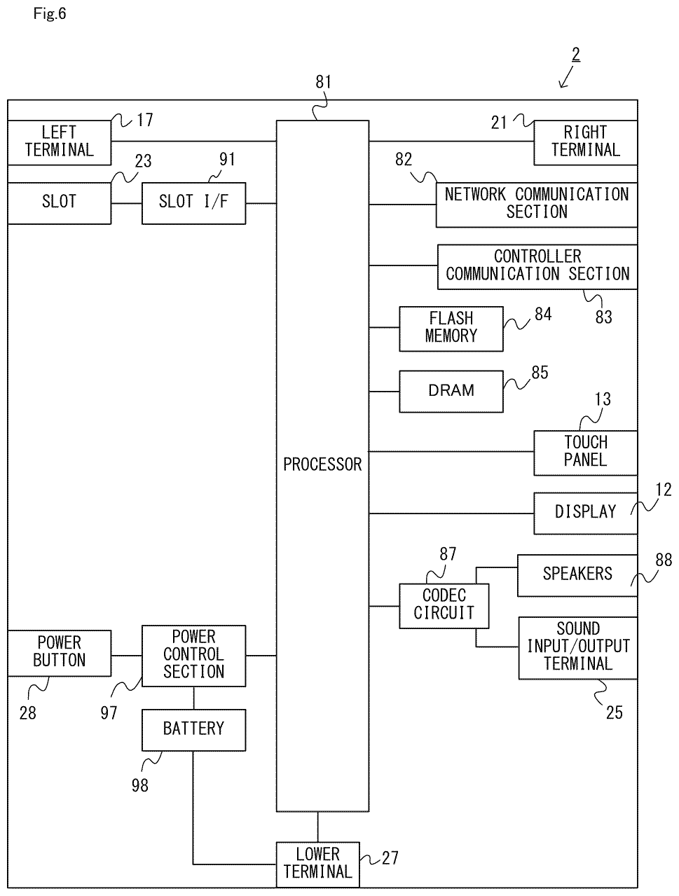

The main body apparatus 2 includes speakers (i.e., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and output from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

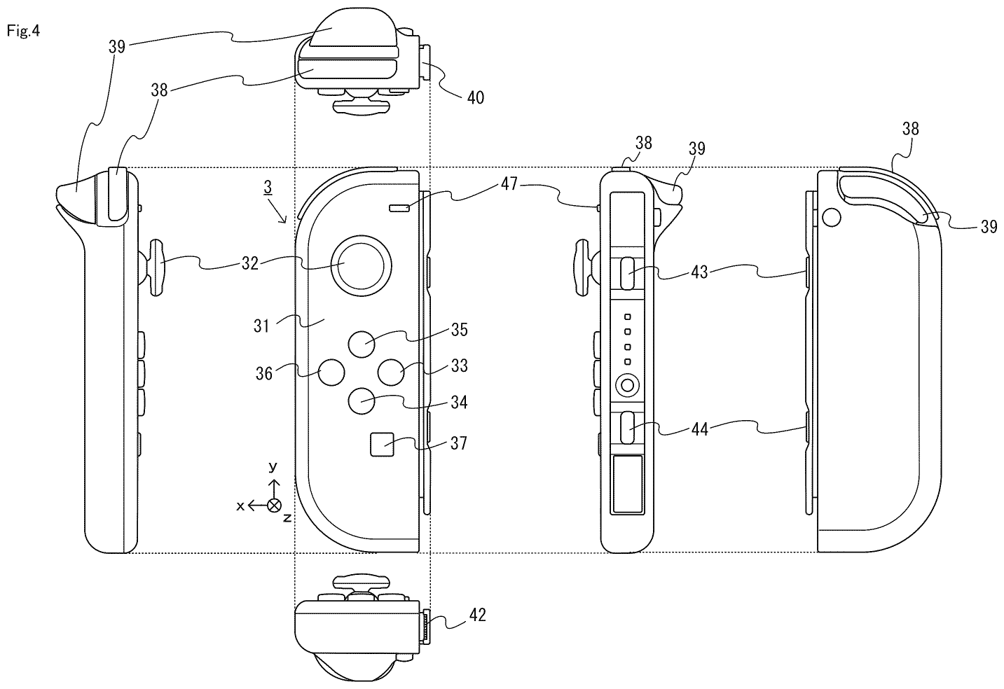

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction (i.e., a y-axis direction shown in FIGS. 1 and 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

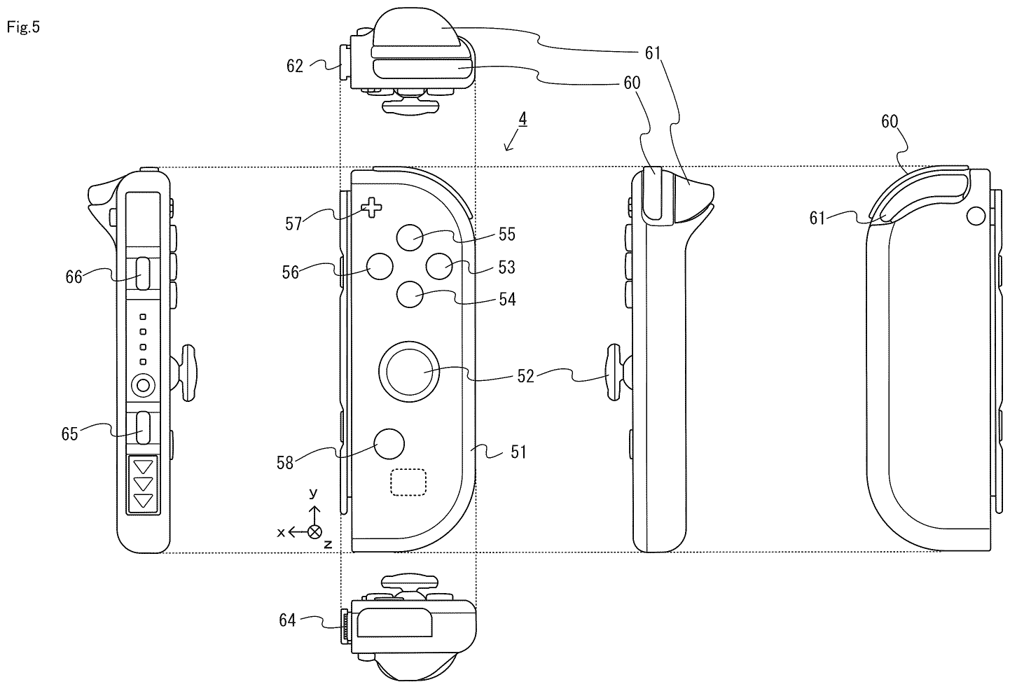

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

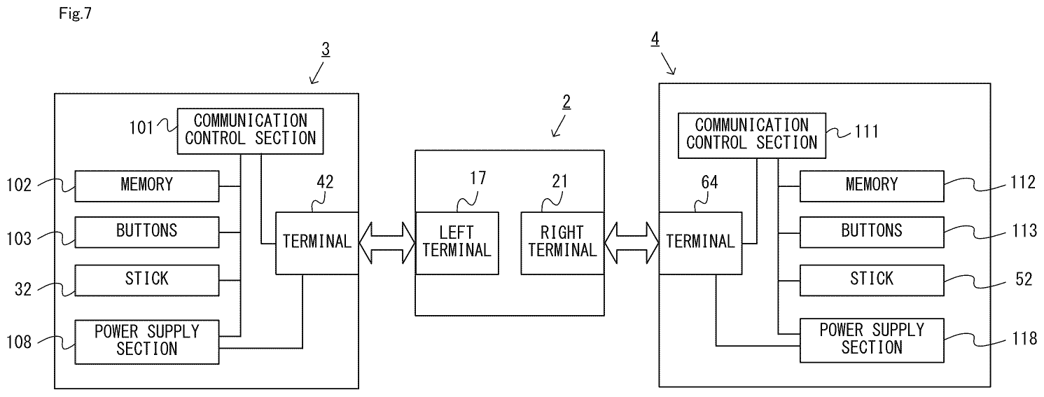

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Processing in Game System]

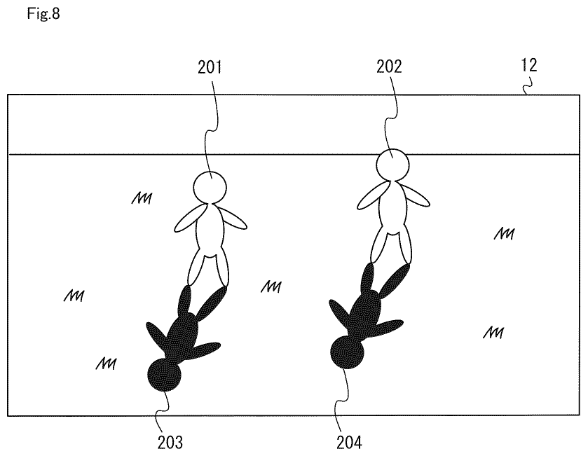

Hereinafter, a game image generating process executed by the game system 1 will be described. In the exemplary embodiment, the game system 1 places an object in a three-dimensional virtual space as a game space, generates a game image showing the virtual space in which a shadow is added to the object, and displays the game image. FIG. 8 shows an example of the game image. As shown in FIG. 8, in the exemplary embodiment, a predetermined type of objects are placed in the virtual space such that shadows are added to the objects (i.e., regions of the shadows are darkened). In the example shown in FIG. 8, shadows 203 and 204 are added to two objects 201 and 202, respectively. In the exemplary embodiment, the predetermined type of objects include a player character to be operated by a player, and a non-player character whose motion is controlled by the game system 1. The game system 1 may add a shadow to any object placed in the virtual space, and may add shadows to all the objects in the virtual space.

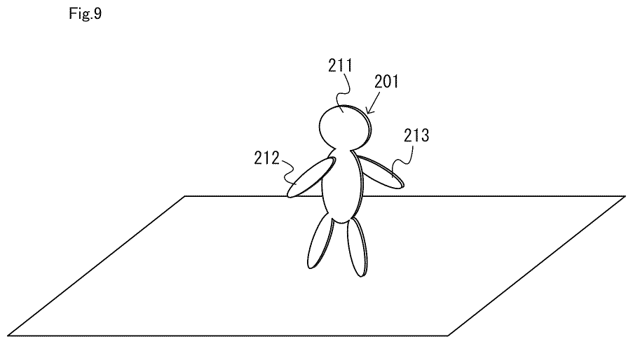

FIG. 9 shows an example of the predetermined type of object placed in the virtual space. In the exemplary embodiment, the predetermined type of object has a flat shape like an object 201 shown in FIG. 9. Specifically, the object 201 includes a main body part (specifically, a part including a head, a torso, and legs) 211, a right arm part 212, and a left arm part 213. Each of the parts 211 to 213 has a planar shape. Although each of the parts 211 to 213 has a slight thickness in FIG. 9, each of the parts 211 to 213 may not necessarily have a thickness. In the exemplary embodiment, each of the parts 211 to 213 is placed so as to be shifted in the thickness direction (see FIG. 9). Therefore, the object 201 has a slight thickness as a whole. In other embodiments, the object may have a planar shape as a whole. In other embodiments, the object may have a non-flat shape.

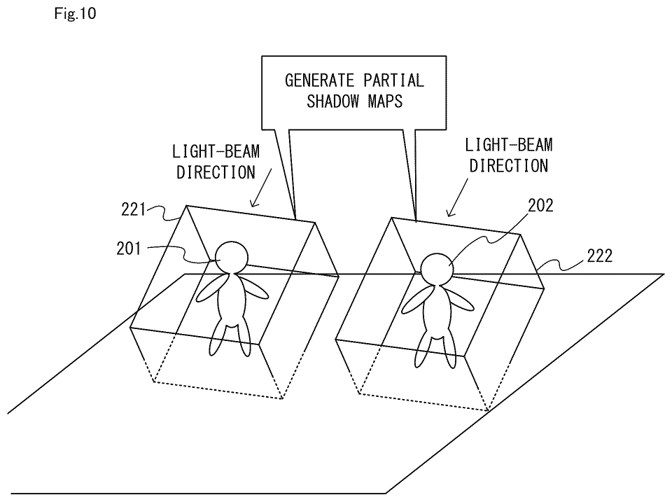

In the exemplary embodiment, in a case where shadows are added to a plurality of objects of the predetermined type placed in the virtual space, the game system 1 performs a process of calculating a region to be a shadow, for each object. Hereinafter, this process will be described with reference to FIG. 10 to FIG. 16.

In the exemplary embodiment, the game system 1 sets a partial space for each of the predetermined type of objects, and generates a shadow map for each object (hereinafter referred to as “partial shadow map”) by using the partial space. FIG. 10 shows an example of partial spaces set for the respective objects. In the example shown in FIG. 10, a partial space 221 is set for the object 201, and a partial space 222 is set for the object 202.

The partial space is set so as to enclose the corresponding object (i.e., an object to which a shadow is added by using the partial space) (see FIG. 10). The partial space may have any size that encloses the corresponding object. Since it is enough for the partial space to enclose the corresponding object, it is not necessary to set a large partial space that encloses a plurality of objects, for example. This inhibits the partial shadow map from increasing in size, and inhibits a memory area used for the partial shadow map from increasing.

In the exemplary embodiment, the partial space has a rectangular parallelepiped shape having sides along the direction of a light beam from a light source (more specifically, sides parallel to the light-beam direction) (see FIG. 10). Although described in detail later, the partial space having the above shape facilitates calculations for generating a partial shadow map within a range corresponding to the partial space. In the exemplary embodiment, the light source for imparting a shadow is a parallel light source. Therefore, the partial spaces set for the respective objects are in the same orientation (see FIG. 10). The partial space may have any shape. In other embodiments, the partial space may have a shape other than a rectangular parallelepiped.

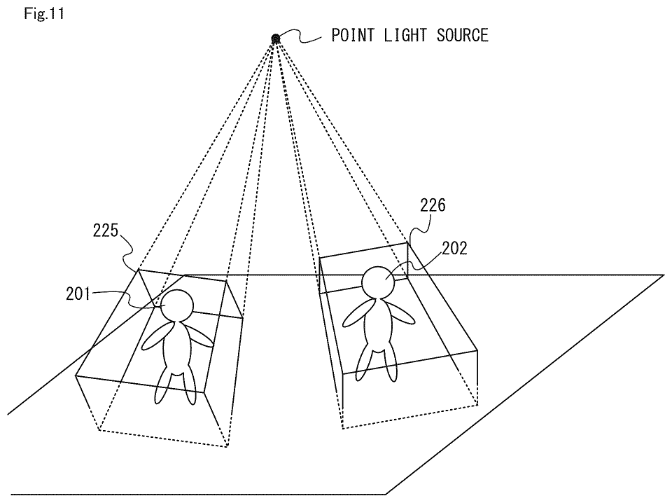

FIG. 11 shows an example of a partial space according to a modification of the exemplary embodiment. In the modification shown in FIG. 11, a point light source is used as a light source for imparting a shadow. In this case, the game system 1 may set partial spaces 225 and 226, each having a truncated cone shape, for the objects 201 and 202, respectively, based on the position of the point light source. Specifically, each of the partial spaces 225 and 226 is a truncated cone obtained by removing, from a square pyramid having an apex at the position of the point light source, a square pyramid that has the same apex and is analogously reduced in size from the square pyramid. With the point light source, a partial shadow map for each object can be generated by using the partial space.

In the exemplary embodiment, a partial shadow map is generated for each partial space, based on the partial space (see FIG. 10). The partial shadow map indicates a depth of each of positions in the partial space as viewed in the light-beam direction. Since the parallel light source is used in the exemplary embodiment, the depth is calculated as a distance in the light-beam direction from a predetermined reference position (i.e., the position of the light source) to the certain position. The reference position may be any position.

The depth of the partial shadow map is calculated for only the object corresponding to the partial space. That is, in the partial shadow map, regarding a position where the object is present as viewed in the light-beam direction, the depth is calculated as a distance in the light-beam direction from the predetermined reference position to the position of the object. Meanwhile, in the partial shadow map, regarding a position where the object is absent as viewed in the light-beam direction, the depth is set to a maximum value. Therefore, in the exemplary embodiment, even if another object is placed in front of or behind the object as seen in the light-beam direction, the depth of the partial shadow map is calculated without considering the other object.

The game system 1 generates a partial shadow map for each object for which a partial space is set. In the exemplary embodiment, when the game system 1 has generated a partial shadow map for one object, the game system 1 executes a process of updating a shadow buffer (described in detail later) based on the partial shadow map, and thereafter generates a partial shadow map for another object. That is, the game system 1 repeats, for each object, a process of generating a partial shadow map and a process of updating a shadow buffer based on the partial shadow map. In this case, since the number of partial shadow maps to be simultaneously stored in the memory area is only one, the memory area for the partial shadow map can be saved. In other embodiments, the partial shadow map generating process and the shadow buffer updating process may be executed in any order. The game system 1 may generate partial shadow maps for the respective objects, and thereafter, execute the shadow buffer updating process based on the partial shadow maps.

The game system 1 updates the shadow buffer, based on the generated partial shadow map. The shadow buffer is a buffer that stores the density (in other words, brightness) of shadow for each of pixels in the game image. The game system 1 calculates a density of shadow at a pixel corresponding to the partial space (i.e., a pixel displayed at a position in the partial space) among the pixels in the shadow buffer, by using the partial shadow map for the partial space. That is, in the shadow buffer updating process based on one partial shadow map, the density of shadow is updated for the pixel corresponding to a region in the partial space corresponding to the partial shadow map.

In the exemplary embodiment, the density of shadow is calculated using a method of variance shadow mapping. In the method of variance shadow mapping, a probability that a position corresponding to a pixel becomes a shadow is represented by Chebyshev's inequality, and a density of shadow is calculated so as to be a density according to the probability (i.e., a portion highly likely to be a shadow becomes a dense shadow while a portion less likely to be a shadow becomes a light shadow). Specifically, in the exemplary embodiment, variable P representing a density of shadow at a pixel is calculated according to the following formula (1).

$$P = {σ}^{2} / \{ {σ}^{2} + {( t - E ( x ) )}^{2} \} \qquad ( 1 )$$

Although described in detail later, the smaller the value of variable P is, the denser (i.e., darker) the shadow is.

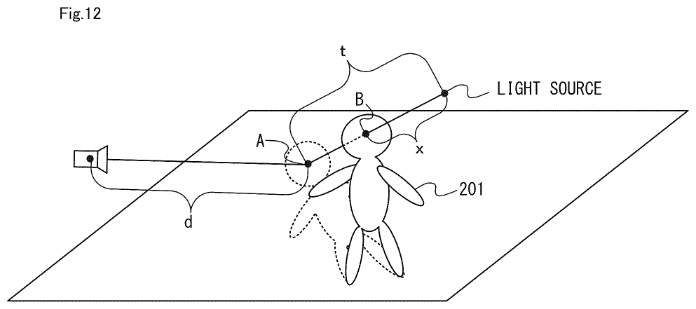

FIG. 12 shows an example of positional relationship between a light source, an object, and a surface (e.g., the ground in the virtual space) to which a shadow of the object is added. A variable t in the above formula (1) is a depth at a position corresponding to a pixel concerned (e.g., position A shown in FIG. 12). Here, the depth in the above formula (1) is a depth based on the light source (i.e., a depth from the position of the light source to the position corresponding to the pixel). The variable t is obtained by converting a depth d based on the virtual camera into a depth based on the light source (see FIG. 12). The depth d based on the virtual camera is stored in a depth buffer. A value of the depth stored in the depth buffer may be calculated by a conventional method.

A variable x in the above formula (1) is a depth, at a position corresponding to the pixel, which is stored in the partial shadow map. That is, the variable x is a depth based on the light source, and if an object is present between the position of the light source and the position corresponding to the pixel (e.g., position A shown in FIG. 12), the variable x is a distance from the position of the light source to the position of the object (e.g., position B shown in FIG. 12).

A function E(x) in the above formula (1) represents a value of a result of applying a predetermined smoothing filter to the depth x. A variable σ² in the above formula (1) is a variance of a depth at the position corresponding to the pixel (more specifically, a local variance around the pixel). Specifically, the variable 62 is calculated according to the following formula (2).

$${σ}^{2} = E ( {x}^{2} ) - {E ( x )}^{2} \qquad ( 2 )$$

In the exemplary embodiment, the function E(x) in the above formulae (1) and (2) is a function representing the result of applying the smoothing filter to the depth. In other embodiments, the function E(x) may be a function representing an average value of depths (e.g., an average value of depths at pixels within a predetermined range inducing the pixel.

If an object is present on a straight line from the light source to the pixel, the variable t becomes larger than the E(x) (see FIG. 12). In this case, the pixel is a pixel at which a shadow of the object is rendered. Meanwhile, if an object is not present on the straight line from the light source to the pixel, the variable t is equal to or smaller than the above E(x). In this case, the pixel is a pixel at which a shadow of an object is not rendered. Therefore, the game system 1 calculates a variable P according to the above formula (1) if the variable t is larger than the E(x). Meanwhile, if the variable t is equal to or smaller than the E(x), a variable P is not calculated. In this case, the value of the pixel in the shadow buffer is not updated. In other embodiments, the game system 1 may compare the variable t with the variable x instead of comparing the variable t with the E(x).

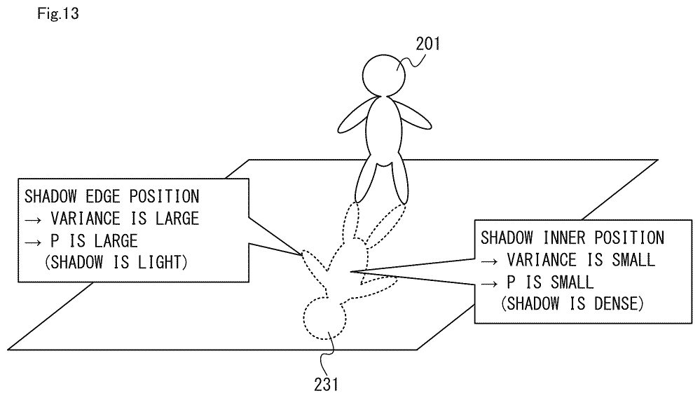

FIG. 13 shows an example of an object and a region to be a shadow of the object. In FIG. 13, it is assumed that a region 231 of the ground in the virtual space is a region in which a shadow of the object 201 is rendered. Here, the variable P calculated by the above formula (1) indicates that the larger the value thereof is, the brighter the region is (in other words, the lighter the shadow is). According to the above formula (1), at a position near an edge of the region 231 to be a shadow of the object 201, since the variance 62 is large, the value of the variable P is large. The reason why the variance σ² is large at such a position is as follows. That is, the periphery of this position includes a position where the variable x is a depth from the light source to the object (i.e., a position to be a shadow), and a position where the variable x is a depth from the light source to the ground (i.e., a position not to be a shadow), and therefore, variation in the value of the variable x increases. Thus, the shadow is light at the position near the edge of the region 231 to be a shadow of the object 201 (see FIG. 13). Meanwhile, at an inner position apart from the edge of the region 231, since the variable x is a depth from the light source to the object at the periphery of this position, variation in the value of the variable x is small. Therefore, the variance σ² is small, and the value of the variable P is small. As a result, at the inner position apart from the edge of the region 231, the shadow is dense (see FIG. 13). As described above, according to the method of variance shadow mapping, since the outline of the shadow is blurred, jaggies are not likely to occur at the edge of the shadow, whereby a natural-looking shadow can be displayed.

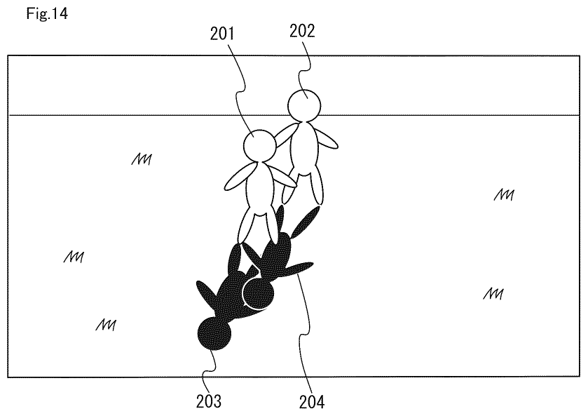

In the method of variance shadow mapping, since the shadow is likely to be light (i.e., bright) at the edge of the shadow region of one object, if two objects are displayed so as to overlap each over, there is a risk of a phenomenon in which a portion to be displayed darkly at the edge is displayed bright (so-called light bleeding). FIG. 14 shows an example of a game image in which shadows of two objects are displayed so as to overlap each other. FIG. 14 shows a situation that a shadow 203 of the object 201 and a shadow 204 of the object 202 are displayed so as to overlap each other. Under such a situation, an unnatural display may occur in which the edge of the region of the shadow 204 is displayed bright, and the outline of the shadow 204 is displayed bright at the boundary between the shadow 203 and the shadow 204. For example, in the case where a single shadow map is generated with respect to the entire rendering range in the virtual space (in contrast to generating a plurality of partial shadow maps for the respective objects as in the exemplary embodiment) and a density of shadow is calculated by the method of variance shadow mapping using the shadow map, there is a risk of light bleeding. In the exemplary embodiment, the game system 1 performs processing as follows in order to reduce the risk of an unnatural shadow being displayed as described above.

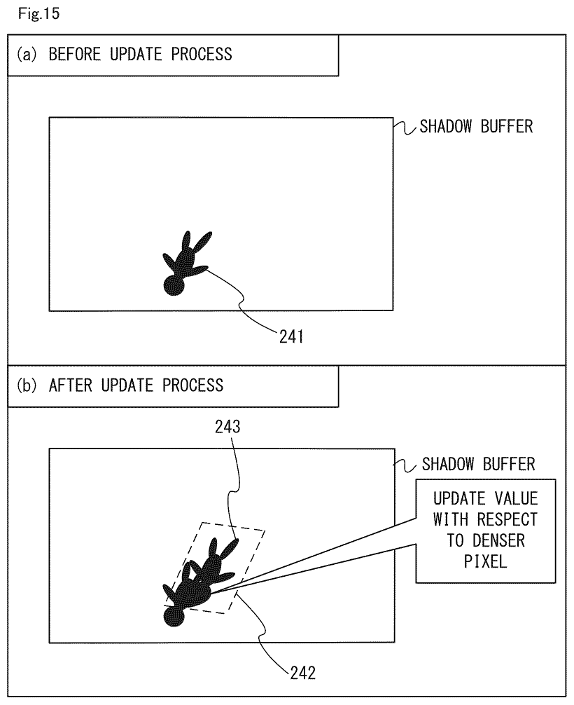

FIG. 15 shows an example of update of a shadow buffer. In the example shown in FIG. 15, after a value of density of shadow based on the partial shadow map for the first object 201 has been stored in the shadow buffer, the shadow buffer is updated using the partial shadow map for the second object 202.

The state shown in (a) of FIG. 15 is a state before the shadow buffer is updated by using the partial shadow map for the second object 202, i.e., a state where only the shadow 241 of the first object 201 is rendered in the shadow buffer.

In updating the shadow buffer by using the partial shadow map for the second object 202, whether or not to update the density of shadow is determined for pixels in a region 242 corresponding to the partial space of the object 202, among the pixels in the shadow buffer. Specifically, the game system 1 does not perform update for a pixel outside the region of the shadow of the object 202 (i.e., a pixel whose variable t is equal to or smaller than E(x)) among the pixels in the region 242. Regarding a pixel within the region of the shadow of the object 202 (i.e., a pixel whose variable t is larger than E(x)) among the pixels in the region 242, the game system 1 updates the value in the shadow buffer if the variable P calculated according to the above formula (1) is smaller than the value stored in the shadow buffer (i.e., if the calculated density of shadow is higher than the density stored in the shadow buffer). Therefore, in the case where a pixel in the shadow 241 of the first object 201 is located inside the shadow 243 of the second object 202, the value of this pixel is updated if the density of the pixel in the shadow 241 is higher than that in the shadow 243, whereas the value of this pixel is not updated if the density in the shadow 243 is lower than that in the shadow 241. According to the above, even if the shadow is calculated to be light in a pixel at the edge of the shadow 243 of the second object 202, the value of this pixel is not updated as long as the value stored in the shadow buffer (i.e., the value indicating the density of the shadow 241 of the first object 201) indicates that the shadow is dense. Therefore, the value indicating that the shadow is dense in this pixel remains stored.

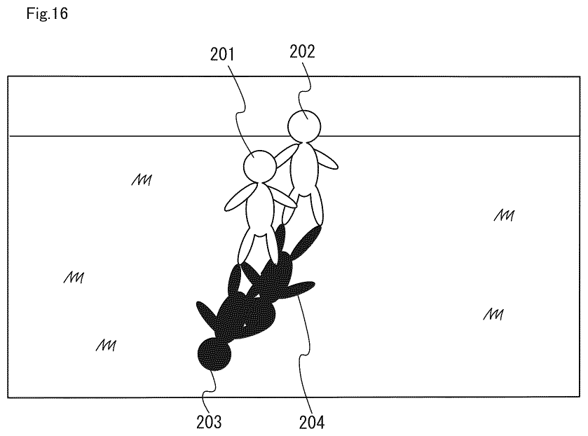

According to the above, in the case where the shadows of two objects are displayed so as to overlap each other, the risk of occurrence of light bleeding can be reduced. FIG. 16 shows a game image which is generated through processing in the exemplary embodiment and in which the shadows of two objects are displayed so as to overlap each other. In the example shown in FIG. 16, a boundary portion between the shadow 203 of the object 201 and the shadow 204 of the object 202 is displayed darkly, in contrast to the example shown in FIG. 14. Thus, in the exemplary embodiment, the shadow buffer is updated for each partial shadow map, and update is performed when the density of shadow is higher than the value stored in the shadow buffer, whereby the risk of occurrence of light bleeding can be reduced.

Also in a case where a plurality of objects are included in one partial space, if the depth based on the light source significantly differs between a certain position and a position around the certain position, the aforementioned variance 62 is increased, which may result in occurrence of light bleeding at the certain position. In this regard, in the exemplary embodiment, the depth of the partial shadow map is calculated only for the object corresponding to the partial space, as described above. According to this as well, the possibility of increase in difference between the depths in the partial shadow maps can be reduced, whereby it is possible to reduce the risk of occurrence of light bleeding due to an increase in the variance σ².

Moreover, in the exemplary embodiment, the predetermined type of object to which a shadow is added has a flat shape. Therefore, the depth in the partial shadow map continuously changes or there is no significant change in depth between a certain position and a position around the certain position, which makes the variance 62 not likely to increase. According to this as well, the risk of occurrence of light bleeding can be reduced. Moreover, in a state where the flat object is oriented almost parallel to the light-beam direction, the amount of change in the depth in the partial shadow map increases. However, since the object is flat in the exemplary embodiment, the shadow is narrow in this state, which makes a problem of the shadow looking unnatural less likely to occur.

The game system 1 performs the shadow buffer updating process by sequentially updates the shadow buffer by using the partial shadow map for each object, thereby updating the shadow buffer. Then, the game system 1, using the updated shadow buffer, performs a lighting process on a game image rendered in a frame buffer, thereby generating a game image in which a shadow is added. The specific content of the lighting process is optional, and a conventional method may be adopted.

### [3. Specific Example of Processing in Information Processing System/Game System]

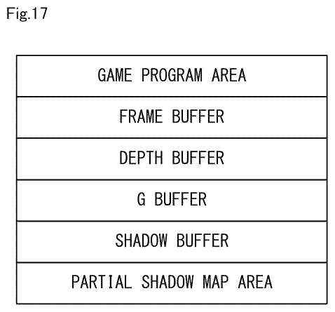

Next, a specific example of information processing in the game system 1 will be described with reference to FIG. 17 to FIG. 22.

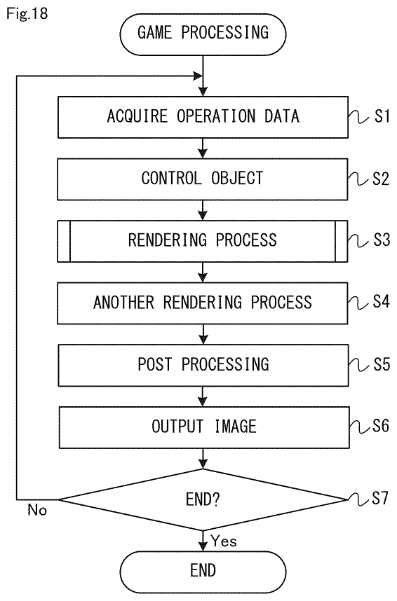

FIG. 17 shows an example of storage areas in which various data to be used for information processing in the game system 1 are stored. Each storage area shown in FIG. 17 is provided in a storage medium (e.g., the flash memory 84, the DRAM 85, a memory card inserted in the slot 23, and/or the like) accessible by the main body apparatus 2. As shown in FIG. 17, a game program area in which a game program is stored is provided in the storage medium. The game program is a program for executing game processing (specifically, game processing shown in FIG. 18) in the exemplary embodiment. In addition, a frame buffer, a depth buffer, a G buffer, a shadow buffer, and a partial shadow map area are provided in the storage medium (see FIG. 17).

FIG. 18 is a flowchart showing an example of a flow of game processing executed by the game system 1. Execution of the game processing is started, for example, when the game has been started according to an instruction of a player during execution of the game program.

In the exemplary embodiment, the processor 81 of the main body apparatus 2 executes the game program stored in the game system 1, thereby executing processes in steps shown in FIG. 18. However, in other embodiments, some of the processes in the steps may be executed by a processor (e.g., a dedicated circuit or the like) other than the processor 81. If the game system 1 is communicable with another information processing apparatus (e.g., a server), some of the processes in the steps shown in FIG. 18 may be executed by the other information processing apparatus. The processes in the steps shown in FIG. 18 are merely examples, and the processing order of the steps may be changed or another process may be executed in addition to (or instead of) the processes in the steps as long as similar results can be obtained.

The processor 81 executes the processes in the steps shown in FIG. 18 by using a memory (e.g., the DRAM 85). That is, the processor 81 stores information (in other words, data) obtained through each process step into the memory, and reads out the information from the memory when using the information for the subsequent process steps.

In step S1 shown in FIG. 18, the processor 81 acquires the operation data indicating an instruction of the player. That is, the processor 81 acquires the operation data received from the controllers via the controller communication section 83 and/or the terminals 17 and 21. Next to step S1, the process in step S2 is executed.

In step S2, the processor 81 controls the motion of the object placed in the virtual space. For example, the processor 81 controls the motion of the player character based on the operation data acquired in step S1, and controls the motion of the non-player character according to an algorithm defined in the game program. Next to step S2, the process in step S3 is executed.

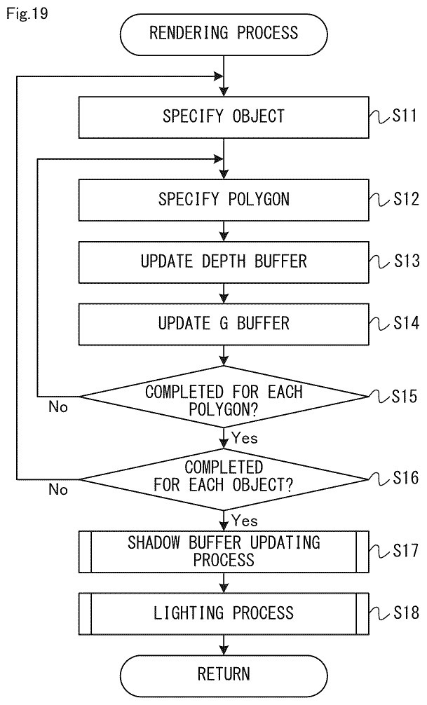

In step S3, the processor 81 executes a rendering process including a process of adding a shadow to the predetermined type of object. In the rendering process in step S3, rendering related to the predetermined type of object, etc., is performed in the virtual space in which the processing result in step S2 is reflected. Hereinafter, the rendering process in step S3 will be described in detail with reference to FIG. 19.

FIG. 19 is a sub-flowchart showing an example of a specific flow of the rendering process in step S3 shown in FIG. 18. In the rendering process, firstly, in step S11, the processor 81 specifies an object to be subjected to rendering. In step S11, an object, which is not yet specified as a target object in the current processing loop of steps S11 to S16, is specified. Next to step S11, the process in step S12 is executed.

In step S12, the processor 81 specifies a polygon to be subjected to rendering among polygons in the object specified in step S11. In step S12, a polygon, which is not yet specified as a target polygon in the current processing loop of steps S12 to S15, is specified. Next to step S12, the process in step S13 is executed.

In step S13, the processor 81 performs a depth test on the polygon specified in step S12, and updates the depth buffer. That is, if a depth value for each pixel stored in the depth buffer is larger than a depth value at a position of the corresponding pixel in the polygon, the processor 81 updates the depth buffer so that the depth value in the depth buffer becomes the depth value in the polygon. Next to step S12, the process in step S13 is executed.

In step S14, the processor 81 updates the G buffer (geometry buffer) for the polygon specified in step S12. That is, the processor 81 writes, in the G buffer, information to be used for rendering (e.g., information such as the position, normal, color, etc., of the polygon) for the pixel corresponding to the polygon. Next to step S14, the process in step S15 is executed.

In step S15, the processor 81 determines whether or not a series of processes in steps S12 to S14 have been completed for each of the polygons in the object specified in step S11. When the determination result in step S15 is positive, the process in step S16 is executed. When the determination result in step S15 is negative, the process in step S12 is executed again.

In step S16, the processor 81 determines whether or not a series of processes in steps S11 to S15 have been completed for each of the objects to be subjected to the rendering process. When the determination result in step S16 is positive, the process in step S17 is executed. When the determination result in step S16 is negative, the process in step S11 is executed again.

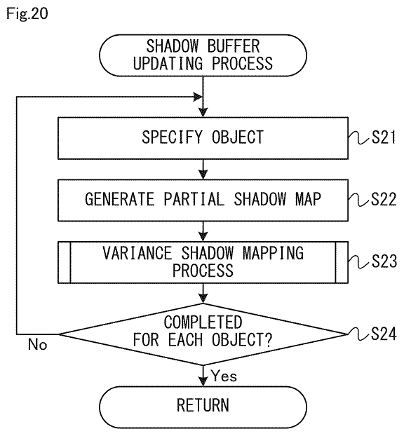

In step S17, the processor 81 executes a shadow buffer updating process of updating the shadow buffer. The shadow buffer updating process is a process of updating the values in the shadow buffer so as to indicate the shadows for the predetermined type of objects. Hereinafter, the shadow buffer updating process in step S17 will be described in detail with reference to FIG. 20.

FIG. 20 is a sub-flowchart showing an example of a specific flow of the shadow buffer updating process in step S17 shown in FIG. 19. In the shadow buffer updating process, firstly, in step S21, the processor 81 specifies an object to be subjected to rendering of shadow. In step S21, among the predetermined type of objects, an object, which is not yet specified as a target object in the current processing loop of steps S21 to S29, is specified. Next to step S21, the process in step S22 is executed.

In step S22, the processor 81 generates a partial shadow map for the object specified in step S21. That is, the processor 81 sets the aforementioned partial space for the object (see FIG. 10), and generates a partial shadow map based on the set partial space. In the exemplary embodiment, if a partial shadow map indicating a value regarding another partial space different from the set partial space is stored in the aforementioned partial shadow map area, the partial shadow map area is overwritten and updated with the content of the newly generated partial shadow map. Next to step S22, the process in step S23 is executed.

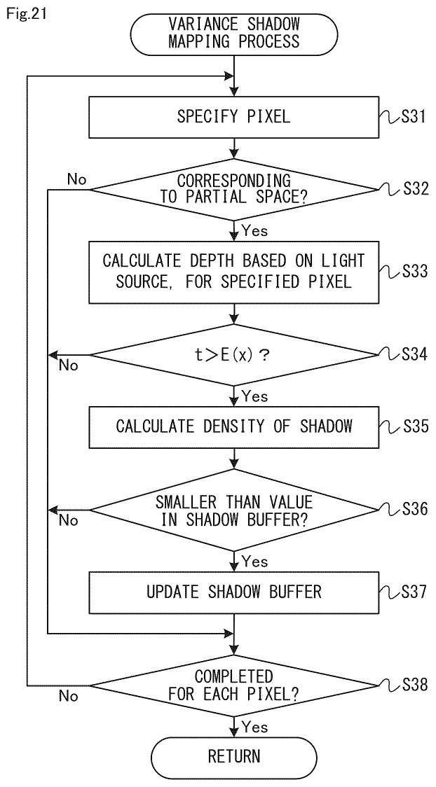

In step S23, the processor 81 executes a variance shadow mapping process of calculating a density of shadow by the aforementioned method of variance shadow mapping. In the variance shadow mapping process, a density of shadow is calculated pixel by pixel for the object specified in step S21, and the shadow buffer is updated according to the calculated density of shadow. Hereinafter, the variance shadow mapping process in step S23 will be described in detail with reference to FIG. 21.

FIG. 21 is a sub-flowchart showing an example of a specific flow of the variance shadow mapping process in step S23 shown in FIG. 20. In the variance shadow mapping process, firstly, in step S31, the processor 81 specifies one pixel to be processed, from among the pixels in the shadow buffer. In step S31, a pixel, which is not yet specified as a target pixel in the current processing loop of steps S31 to S38, is specified. Next to step S31, the process in step S32 is executed.

In step S32, the processor 81 determines whether or not the pixel specified in step S31 is a pixel corresponding to the partial space that is set for the object specified in step S21. The pixel corresponding to the partial space is a pixel indicating a position within the partial space, or a pixel such that the partial space is placed in front of the position indicated by the pixel as viewed in the light source direction. When the determination result in step S32 is positive, the process in step S33 is executed. When the determination result in step S32 is negative, the process in step S38 described later is executed.

In step S33, the processor 81 calculates a depth based on the light source, for the pixel specified in step S31. That is, the processor 81 convers a depth (d in FIG. 12) based on the virtual camera and stored in the depth buffer into a depth (t in FIG. 12) based on the light source. Next to step S33, the process in step S34 is executed.

In step S34, the processor 81 determines whether or not the depth t calculated in step S33 is larger than E(x) based on the depth x stored in the partial shadow map. When the determination result in step S34 is positive, the process in step S35 is executed. When the determination result in step S34 is negative, the process in step S38 described later is executed.

In step S35, the processor 81 calculates a density of shadow for the pixel specified in step S31. Specifically, the processor 81 calculates a variable P representing a density of shadow, according to the above formula (1). Next to step S35, the process in step S36 is executed.

In step S36, the processor 81 determines, for the pixel specified in step S31, whether or not the value indicating the density of shadow calculated in step S35 is smaller than that of the pixel stored in the shadow buffer (i.e., whether or not the calculated density of shadow is higher than the density stored in the shadow buffer). When the determination result in step S36 is positive, the process in step S37 is executed. When the determination result in step S36 is negative, the process in step S38 described later is executed.

In step S37, the processor 81 updates, for the pixel specified in step S31, the value stored in the shadow buffer to the value calculated in step S35. Next to step S37, the process in step S38 is executed.

In step S38, the processor 81 determines whether or not a series of processes in steps S31 to S37 have been completed for each of the pixels in the shadow buffer. When the determination result in step S38 is negative, the process in step S31 is executed again. When the determination result in step S38 is positive, the processor 81 ends the variance shadow mapping process.

Referring back to FIG. 20, next to the variance shadow mapping process (step S23), the process in step S24 is executed. In step S24, the processor 81 determines whether or not a series of processes in steps S21 to S23 have been completed for each object to be subjected to rendering of shadow. When the determination result in step S24 is negative, the process in step S21 is executed again. When the determination result in step S24 is positive, the processor 81 ends the shadow buffer updating process.

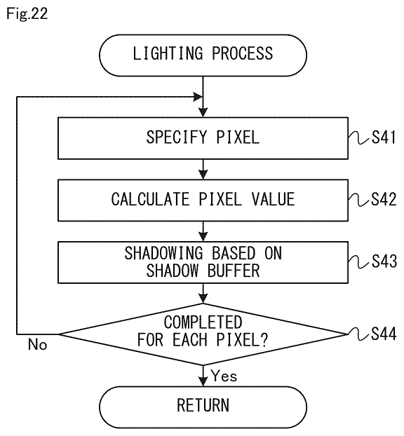

Referring back to FIG. 19, next to the shadow buffer updating process (step S17), the process in step S18 is executed. In step S18, the processor 81 performs a lighting process. In the lighting process, a pixel value of each pixel in consideration of the light source in the virtual space is calculated. Hereinafter, the lighting process in step S18 will be described in detail with reference to FIG. 22.

FIG. 22 is a sub-flowchart showing an example of a specific flow of the lighting process in step S18 shown in FIG. 19. In the lighting process, firstly, in step S41, the processor 81 specifies a pixel whose pixel value is to be calculated. In step S41, a pixel, which is not yet specified as a target pixel in the current processing loop of steps S41 to S44, is specified. Next to step S41, the process in step S42 is executed.

In step S42, the processor 81 calculates a pixel value of the pixel specified in step S41, based on the aforementioned depth buffer and G buffer. The pixel value calculated here is the pixel value in which the shadow in the aforementioned shadow buffer has not yet been reflected. If another light source different from the light source (in the exemplary embodiment, the aforementioned parallel light source) corresponding to the partial space of the predetermined type of object is set in the virtual space, the processor 81 may calculate the pixel value in consideration of the other light source in the process in step S42. The processor 81 updates the frame buffer so as to store the calculated pixel value. Next to step S42, the process in step S43 is executed.

In step S43, based on the aforementioned shadow buffer, the processor 81 executes shadowing for adding a shadow to an image in the frame buffer. That is, based on the pixel value calculated in step S42 for the pixel specified in step S41, the processor 81 calculates a pixel value in which the density of shadow of this pixel, stored in the shadow buffer, is reflected. The processor 81 updates the frame buffer so as to store the calculated pixel value. Next to step S43, the process in step S44 is executed.

In step S44, the processor 81 determines whether or not a series of processes in steps S41 to S43 have been completed for each of the pixels in the frame buffer. When the determination result in step S44 is negative, the process in step S41 is executed again. When the determination result in step S44 is positive, the processor 81 ends the lighting process. With the end of the lighting process, the rendering process shown in FIG. 19 is ended. In the exemplary embodiment, the rendering process shown in FIG. 19 is performed by deferred rendering using the G buffer. In other embodiments, the rendering process may be performed by forward rendering. That is, in the exemplary embodiment, the processor 81 performs rendering to the G buffer in the rendering process (see FIG. 19), and renders an image with a shadow in the frame buffer, based on the G buffer and the shadow buffer, in the lighting process (see FIG. 22). In other embodiments, the processor 81 may perform rendering to the frame buffer in the rendering process, and may render a shadow in an image in the frame buffer, based on the frame buffer and the shadow buffer, in the lighting process.

Referring back to FIG. 18, next to the rendering process (step S3), the process in step S4 is executed. In step S4, the processor 81 executes the rendering process for an object (e.g., background, etc.) that is not rendered in the rendering process in step S3. For example, the rendering process in step S3 may be executed by deferred rendering, and the rendering process in step S4 may be executed by forward rendering. Next to step S4, the process in step S5 is executed.

In step S5, the processor 81 executes post processing. The post processing may have any specific content. For example, the processor 81 adds an effect by using a filter to the game image generated through the processes in step S3 and S4, or adjusts the brightness, saturation, etc., of the game image. Next to step S5, the process in step S6 is executed.

In step S6, the processor 81 outputs the game image after the process in step S5 to the display device. Thus, the game image is displayed on the display device. The display device to which the game image is outputted may be the display 12 of the main body apparatus 2, or the aforementioned stationary monitor connected to the main body apparatus 2. Next to step S6, the process in step S7 is executed.

In step S7, the processor 81 determines whether or not to end the game processing. For example, the processor 81 determines to end the game if a predetermined operation input for ending the game is performed by the player. When the determination result in step S7 is negative, the process in step S1 is executed again. Thereafter, a series of processes in steps S1 to S7 are repeatedly executed until the processor 81 determines to end the game in step S7. When the determination result in step S7 is positive, the processor 81 ends the game processing shown in FIG. 18.

### [4. Function and Effect of the Exemplary Embodiment, and Modifications]

In the above exemplary embodiment, an image processing program (e.g., game program) causes a computer of an information processing apparatus (e.g., the processor 81 of the main body apparatus 2) to execute the following processes:
a process of, regarding objects in a virtual space, performing rendering to a frame buffer or a G buffer while performing a depth test using a depth buffer (step S14);
a process of, regarding a plurality of first type of objects among the objects in the virtual space, setting, for each object, a partial space that is a part of the virtual space and encloses the first type of object (step S22);
a process of, for each object, setting a virtual light source corresponding to the partial space, and generating a partial shadow map that is a shadow map for the first type of object in the partial space based on the virtual light source (step S22);
a process of, regarding pixels corresponding to a range of the partial space for each object, determining, for each pixel, a density of shadow of the first type of object, based on a depth in the depth buffer and a depth of the partial shadow map (step S35), and if the density of shadow of the pixel has a value indicating a denser shadow than a value stored in a shadow buffer that stores densities of shadows (step S37); and
a process of rendering a shadow in an image in the frame buffer, based on the frame buffer and the shadow buffer, or rendering an image with a shadow in the frame buffer, based on the G buffer and the shadow buffer (step S43).

In the above configuration, using the partial shadow map for each object eliminates the necessity of generating a shadow map for the entire rendering range. Therefore, the memory area for the shadow map can be reduced, and the processing load on the computer can be reduced.

In the above exemplary embodiment, a game program that generates a game image has been described as an example of the image processing program that generates an image of a virtual space to which a shadow is added. However, the image processing program is not limited to the game program. The image processing in the exemplary embodiment is applicable to any information processing program for generating an image indicating a virtual space.

In the above exemplary embodiment, the density of shadow for each pixel is calculated based on the method of variance shadow mapping. However, the specific method for calculating the density of shadow is not limited thereto, and the density of shadow may be calculated by any method. According to the exemplary embodiment, using the partial shadow map can inhibit the aforementioned light bleeding even in the case of using the method of variance shadow mapping. Therefore, an additional process for inhibiting light bleeding need not be performed, whereby a shadow that looks natural can be displayed.

In the exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the other information processing apparatus and the data stored therein.

In other embodiments, the information processing system may not include some of the components in the above embodiment, and may not execute some of the processes executed in the above embodiment. For example, in order to achieve a specific effect of a part of the above embodiment, the information processing system only needs to include a configuration for achieving the effect and execute a process for achieving the effect, and need not include other configurations and need not execute other processes.

The exemplary embodiment can be used as, for example, a game system or a game program, in order to, for example, reduce the processing load of the computer.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute information processing comprising:
regarding objects in a virtual space, performing rendering to a frame buffer or a G buffer while performing a depth test using a depth buffer;
regarding a plurality of first type of objects among the objects in the virtual space, for each first type of object,
setting a partial space that is a part of the virtual space and encloses the first type of object,
setting a virtual light source corresponding to the partial space, and generating a partial shadow map that is a shadow map for the first type of object in the partial space based on the virtual light source, and
regarding pixels corresponding to a range of the partial space, determining, for each pixel, a density of shadow of the first type of object, based on a depth in the depth buffer and a depth of the partial shadow map, and if the density of shadow of the pixel has a value indicating a denser shadow than a value stored in a shadow buffer that stores densities of shadows, overwriting and storing the density of shadow of the pixel in the shadow buffer; and
rendering a shadow in an image in the frame buffer, based on the frame buffer and the shadow buffer, or rendering an image with a shadow in the frame buffer, based on the G buffer and the shadow buffer.

2. The one or more non-transitory computer-readable media according to claim 1, wherein
the information processing includes determining the density of shadow for each of the pixels corresponding to the range of the partial space, based on a method of variance shadow mapping using the depth in the depth buffer and the depth of the partial shadow map.

3. The one or more non-transitory computer-readable media according to claim 2, wherein
the first type of object is a flat-shaped object.

4. The one or more non-transitory computer-readable media according to claim 1, wherein
the virtual light source is a parallel light source, and
the partial space has a rectangular parallelepiped shape having sides along a direction of light from the parallel light source.

5. An information processing system comprising one or more processors that execute information processing comprising:
regarding objects in a virtual space, performing rendering to a frame buffer or a G buffer while performing a depth test using a depth buffer;
regarding a plurality of first type of objects among the objects in the virtual space, for each first type of object,
setting a partial space that is a part of the virtual space and encloses the first type of object,
setting a virtual light source corresponding to the partial space, and generating a partial shadow map that is a shadow map for the first type of object in the partial space based on the virtual light source, and
regarding pixels corresponding to a range of the partial space, determining, for each pixel, a density of shadow of the first type of object, based on a depth in the depth buffer and a depth of the partial shadow map, and if the density of shadow of the pixel has a value indicating a denser shadow than a value stored in a shadow buffer that stores densities of shadows, overwriting and storing the density of shadow of the pixel in the shadow buffer; and
rendering a shadow in an image in the frame buffer, based on the frame buffer and the shadow buffer, or rendering an image with a shadow in the frame buffer, based on the G buffer and the shadow buffer.

6. The information processing system according to claim 5, wherein
the information processing includes determining the density of shadow for each of the pixels corresponding to the range of the partial space, based on a method of variance shadow mapping using the depth in the depth buffer and the depth of the partial shadow map.

7. The information processing system according to claim 6, wherein
the first type of object is a flat-shaped object.

8. The information processing system according to claim 5, wherein
the virtual light source is a parallel light source, and
the partial space has a rectangular parallelepiped shape having sides along a direction of light from the parallel light source.

9. An information processing apparatus including one or more processors executing information processing, the information processing comprising:
regarding objects in a virtual space, performing rendering to a frame buffer or a G buffer while performing a depth test using a depth buffer;
regarding a plurality of first type of objects among the objects in the virtual space, for each first type of object,
setting a partial space that is a part of the virtual space and encloses the first type of object,
setting a virtual light source corresponding to the partial space, and generating a partial shadow map that is a shadow map for the first type of object in the partial space based on the virtual light source, and
regarding pixels corresponding to a range of the partial space, determining, for each pixel, a density of shadow of the first type of object, based on a depth in the depth buffer and a depth of the partial shadow map, and if the density of shadow of the pixel has a value indicating a denser shadow than a value stored in a shadow buffer that stores densities of shadows, overwriting and storing the density of shadow of the pixel in the shadow buffer; and
rendering a shadow in an image in the frame buffer, based on the frame buffer and the shadow buffer, or rendering an image with a shadow in the frame buffer, based on the G buffer and the shadow buffer.

10. The information processing apparatus according to claim 9, wherein
the information processing includes determining the density of shadow for each of the pixels corresponding to the range of the partial space, based on a method of variance shadow mapping using the depth in the depth buffer and the depth of the partial shadow map.

11. The information processing apparatus according to claim 10, wherein
the first type of object is a flat-shaped object.

12. The information processing apparatus according to claim 9, wherein
the virtual light source is a parallel light source, and
the partial space has a rectangular parallelepiped shape having sides along a direction of light from the parallel light source.

13. An image processing method executed by an information processing system, the information processing system executing:
regarding objects in a virtual space, performing rendering to a frame buffer or a G buffer while performing a depth test using a depth buffer;
regarding a plurality of first type of objects among the objects in the virtual space, for each first type of object,
setting a partial space that is a part of the virtual space and encloses the first type of object,
setting a virtual light source corresponding to the partial space, and generating a partial shadow map that is a shadow map for the first type of object in the partial space based on the virtual light source, and
regarding pixels corresponding to a range of the partial space, determining, for each pixel, a density of shadow of the first type of object, based on a depth in the depth buffer and a depth of the partial shadow map, and if the density of shadow of the pixel has a value indicating a denser shadow than a value stored in a shadow buffer that stores densities of shadows, overwriting and storing the density of shadow of the pixel in the shadow buffer; and
rendering a shadow in an image in the frame buffer, based on the frame buffer and the shadow buffer, or rendering an image with a shadow in the frame buffer, based on the G buffer and the shadow buffer.

14. The information processing method according to claim 13, wherein
the information processing system determines the density of shadow for each of the pixels corresponding to the range of the partial space, based on a method of variance shadow mapping using the depth in the depth buffer and the depth of the partial shadow map.

15. The information processing method according to claim 14, wherein
the first type of object is a flat-shaped object.

16. The information processing method according to claim 13, wherein
the virtual light source is a parallel light source, and
the partial space has a rectangular parallelepiped shape having sides along a direction of light from the parallel light source.
